(19) United States
(12) Patent Application Publication
(10) Pub. No.: US 2012/0055192 A1
(43) Pub. Date: Mar. 8, 2012

(54) BOTTLE CHILLER AND METHOD OF MANUFACTURING THE SAME

(76) Inventor: Pasquale Savarese, Smithtown, NY (US)

(21) Appl. No.: 13/032,699

(22) Filed: Feb. 23, 2011

Related U.S. Application Data
(63) Continuation-in-part of application No. 29/369,411, filed on Sep. 8, 2010, now Pat. No. D634981.

(51) Int. Cl. F25D 3/02; B65D 85/00; B23P 19/04; B65D 81/18

(52) U.S. Cl. 62/463; 220/592.01; 206/459.1; 220/592.16; 29/428

(57) ABSTRACT

A bottle chiller including a housing and an inner member positioned within the housing is presented, the inner member having a first portion and a second portion such that the first portion rests on the second portion, the inner member including a plurality of spaced apart openings. The first portion has a first diameter and the second portion has a second diameter, the second diameter being greater than the first diameter. The second portion of the inner member is configured to receive water and a vertical gap portion extending from an inner surface of the housing to an outer surface of the first portion of the inner member is configured to receive ice.

### PRIORITY

This application is a continuation-in-part patent application of a design patent application having the title “Bottle Chiller,” filed on Sep. 8, 2010 and assigned U.S. Design patent application Ser. No. 29/369,411; the entire contents of this design patent application are incorporated herein by reference.

### CROSS-REFERENCE TO RELATED APPLICATION

This application is related to a Community Design registration filing made with the Office for Harmonization in the Internal Market on Feb. 15, 2011 titled “Bottle Cooler” and allocated reference number D101475EU01 and Community Design registration number 001821638; the entire contents of this filing are incorporated herein by reference.

### BACKGROUND

1. Field of the Related Art

The present disclosure relates to bottles, and more particularly, but not exclusively, to a bottle chiller for receiving a bottle for quick and efficient cooling.

2. Description of the Related Art

Champagne and select wines are best served chilled. Accordingly, refrigeration devices are often employed to keep such champagne or wine at the proper temperature prior to serving. While the wine is being served and until the bottle is finished, however, it is also preferable to keep the wine chilled. It is inconvenient, however, to repeatedly return the bottle to the refrigerator between pouring.

The practice of cooling individual bottles of wine in a refrigerator or in a bucket of ice is well known. In order to provide faster and more convenient chilling of individual bottles, such as wine bottles, specialized electro-mechanical devices have been proposed. However, such electro-mechanical devices are complex and are cost prohibitive to manufacture. Simpler cooling solutions are desired.

The present disclosure is intended to overcome the drawbacks of conventional bottle chillers by exploiting bottle morphology in order to successfully separate chambers.

### SUMMARY

The present disclosure provides a bottle chiller including a housing and an inner member positioned within the housing, the inner member having a first portion and a second portion such that the first portion rests on the second portion, the inner member including a plurality of spaced apart openings; wherein the first portion has a first diameter and the second portion has a second diameter, the second diameter being greater than the first diameter. The first portion of the inner member is configured to receive a bottle.

Additionally, a top circumferential layer of the second portion of the inner member has a plurality of spaced apart openings for receiving water poured into the housing. The second portion of the inner member is configured to receive water and a vertical gap portion extending from an inner surface of the housing to an outer surface of the first portion of the inner member is configured to receive ice.

In one exemplary embodiment, the inner member may be fixedly secured in the housing. In another exemplary embodiment, the inner member may be removably attached within the housing. Additionally, the first portion of the inner member may be removably attached to the second portion of the inner member.

The second portion slidably engages an inner surface of the housing, whereas the first portion refrains from contacting the inner surface of the housing. Moreover, the housing has a variable length diameter extending downward from a top portion to a bottom portion of the bottle chiller.

In another exemplary embodiment, an exterior surface of the housing includes indicators for indicating one or more parameters, at least one parameter being an interior temperature of the bottle chiller. The indicators are visual indicators, audible indicators or a combination thereof.

An exterior surface of the housing may also include a handle for holding the bottle chiller. The bottle chiller is at least one of a wine chiller, a champagne chiller, a beer chiller or a hard liquor chiller.

The present disclosure also provides a device for chilling liquids. The device includes an outer chamber having a variable length diameter extending a length of the device and an inner chamber having a top portion and a base portion, the base portion having a base diameter greater than a top diameter of the top portion. The inner chamber is configured to receive a bottle and includes a plurality of spaced apart openings.

The present disclosure also provides a method for manufacturing a bottle chiller, the method including forming a housing and forming an inner member positioned within the housing, the inner member having a first portion and a second portion such that the first portion rests on the second portion, the inner member including a plurality of spaced apart openings. The first portion has a first diameter and the second portion has a second diameter, the second diameter being greater than the first diameter. The second portion slidably engages an inner surface of the housing, whereas the first portion refrains from contacting the inner surface of the housing. The housing has a variable length diameter extending downward from a top portion to a bottom portion of the bottle chiller.

Further scope of applicability of the present disclosure will become apparent from the detailed description given hereinafter. However, it should be understood that the detailed description and specific examples, while indicating preferred embodiments of the present disclosure, are given by way of illustration only, since various changes and modifications within the spirit and scope of the present disclosure will become apparent to those skilled in the art from this detailed description.

### BRIEF DESCRIPTION OF THE DRAWINGS

Various embodiments of the present disclosure will be described herein below with reference to the figures wherein:

FIG. 1 is a perspective view of a bottle chiller, in accordance with the present disclosure;

FIG. 2 is a side view of the bottle chiller of FIG. 1, in accordance with the present disclosure;

FIG. 3 is a top view of the bottle chiller of FIG. 1, in accordance with the present disclosure;

FIG. 4 is a bottom view of the bottle chiller of FIG. 1, in accordance with the present disclosure;

FIG. 5 is a cut-away, perspective view of the bottle chiller of FIG. 1, illustrating the inner member of the housing for receiving water and ice, in accordance with the present disclosure; and

FIG. 6 is a cut-away, perspective view of the bottle chiller of FIG. 1, illustrating the inner member receiving a bottle to be chilled with water and ice, in accordance with the present disclosure.

### DETAILED DESCRIPTION

Unless otherwise indicated, all numbers expressing quantities and conditions, and so forth used in the specification and claims are to be understood as being modified in all instances by the term “about.” In this application, the use of the singular includes the plural unless specifically stated otherwise. In this application, the use of “or” means “and/or” unless stated otherwise. Furthermore, the use of the term “including,” as well as other forms, such as “includes” and “included,” is not limiting. Also, terms such as “element” or “component” encompass both elements and components comprising one unit and elements and components that comprise more than one subunit unless specifically stated otherwise. The term “coupled to” means to be attached or connected to directly or indirectly or to be incorporated within.

Reference will now be made in detail to embodiments of the present disclosure. While certain embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

Embodiments will be described below while referencing the accompanying figures. The accompanying figures are merely examples and are not intended to limit the scope of the present disclosure.

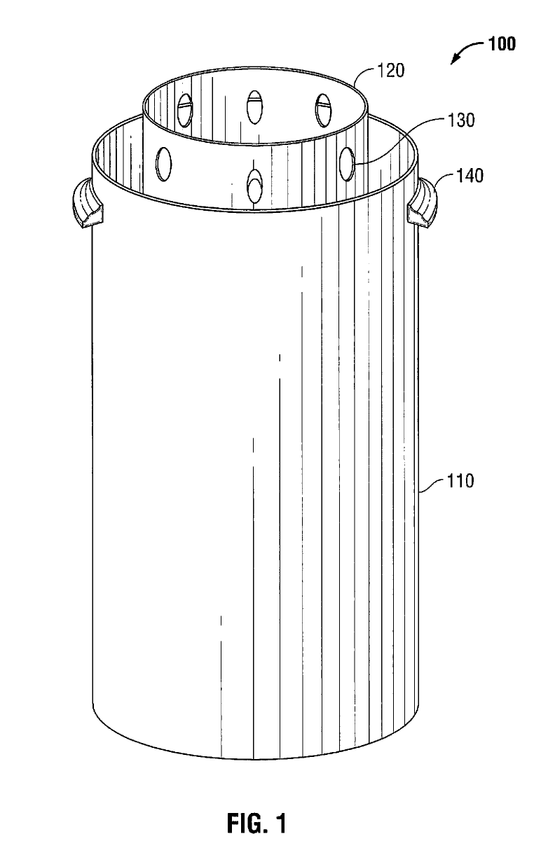

With reference to FIG. 1 there is presented a perspective view of a bottle chiller 100, in accordance with the present disclosure.

The bottle chiller 100 includes a housing 110 and an inner member 120. The inner member 120 includes a plurality of spaced apart openings 130. The housing 110 may also include a handle 140.

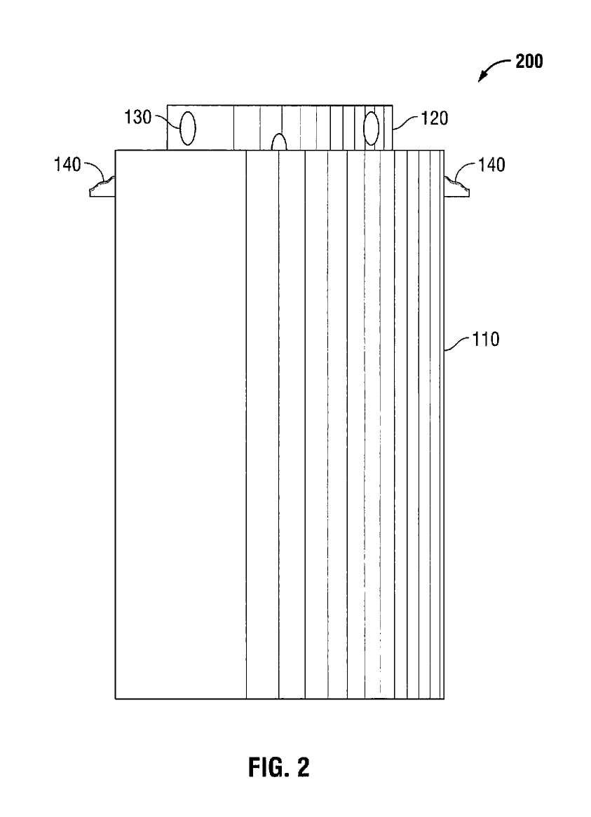

With reference to FIG. 2, there is presented a side view 200 of the bottle chiller of FIG. 1, in accordance with the present disclosure.

The inner member 120 is shown to extend above a top portion of the housing 110. Additionally, the plurality of spaced apart openings 130 may extend an entire length of the inner member 120. The openings 130 may be equally spaced apart. The handle 140 may envelop the entire circumference of the housing 110 (one continuous handle 140) or the handle 140 may be positioned on opposed ends of the housing 110 (non-continuous portions).

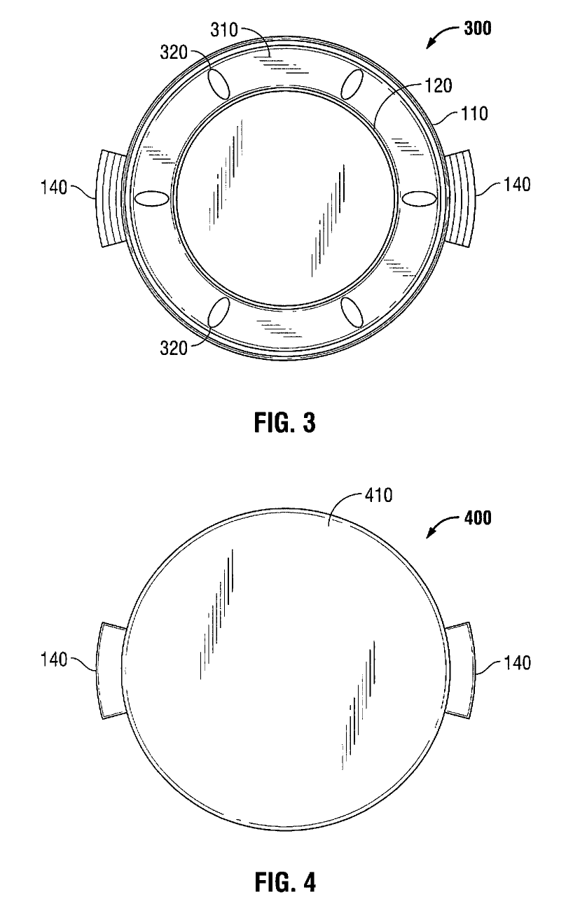

With reference to FIG. 3, there is presented a top view 300 of the bottle chiller of FIG. 1, in accordance with the present disclosure.

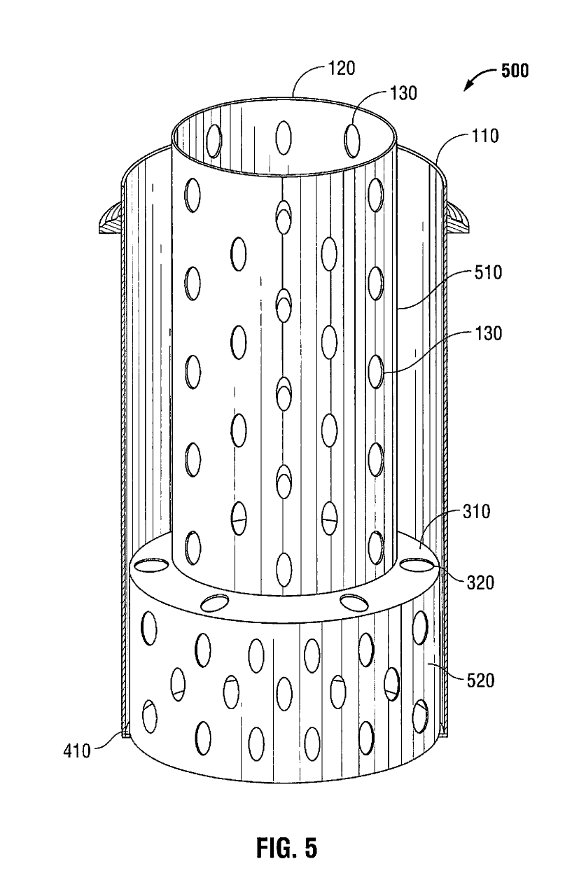

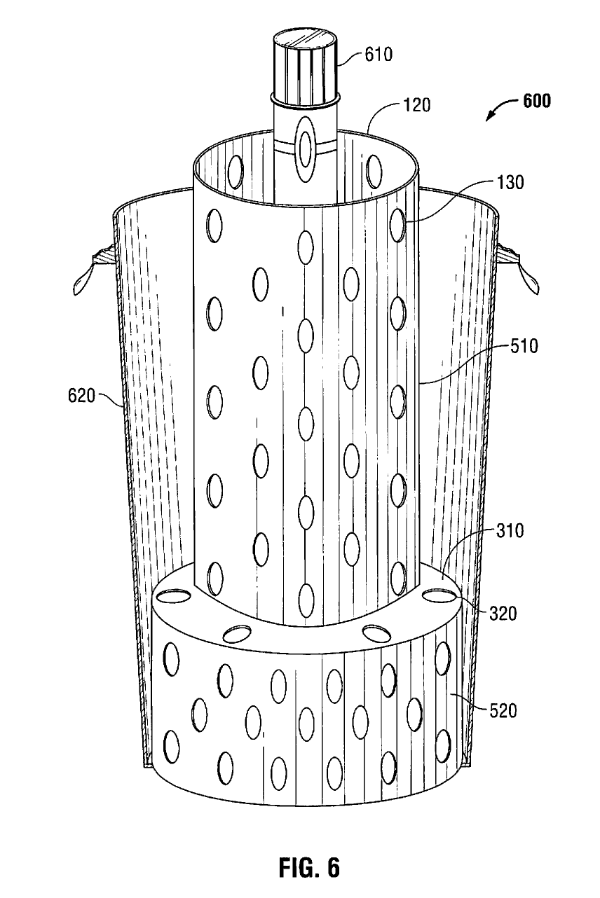

The housing 110 is separated from the inner member 120 by a vertical gap portion extending from an inner surface of the housing 110 to an outer surface of the inner member 120. The top view 300 also illustrates a top circumferential layer 310 having a plurality of openings 320. The plurality of openings 320 are configured to receive water poured into the housing 110 in order to chill a bottle received in the inner member 120 (see FIGS. 5 and 6).

With reference to FIG. 4, there is presented a bottom view 400 of the bottle chiller of FIG. 1, in accordance with the present disclosure.

The bottom view illustrates a base layer 410.

With reference to FIG. 5, there is presented a cut-away, perspective view of the bottle chiller of FIG. 1, illustrating the inner member of the housing for receiving water and ice, in accordance with the present disclosure.

The cut-away view 500 includes the inner member 120 within the housing 110. The inner member 120 includes a plurality of spaced apart openings 130. The inner member 120 is divided into two sections or portions. The inner member 120 includes a first portion 510 and a second portion 520. The first portion 510 rests on the second portion 520. The first portion 510 has a first diameter, whereas the second portion 520 has a second diameter, such that the second diameter is greater than the first diameter. The first portion 510 is configured to receive a bottle (see FIG. 6). The top circumferential layer 310 of the second portion 520 includes a plurality of spaced apart openings 320 for receiving water poured into the housing 110. The second portion 520 of the inner member 120 is configured to receive water and the vertical gap portion extending from an inner surface of the housing 110 to an outer surface of the first portion 510 of the inner member 120 is configured to receive ice.

Therefore, a user may first pour water into the housing 110 until the second portion 520 is full of water. The user may then pour ice in the vertical gap portion, such that the ice surrounds the first portion 510 holding the bottle (see FIG. 6). As the ice melts in the vertical gap portion, it flows through the plurality of openings 130 of the first portion 510 and the plurality of openings 320 of the second portion.

With reference to FIG. 6, there is presented a cut-away, perspective view of the bottle chiller of FIG. 1, illustrating the inner member receiving a bottle to be chilled with water and ice, in accordance with the present disclosure.

The cut-away view 600 includes a bottle 610 received within the first portion 510 of the inner member 120 having a plurality of openings 130. As depicted in FIG. 6, the housing 620 is slightly different than the housing 110 of FIGS. 1-5. The housing 620 has a variable length diameter extending downward from a top portion to a bottom portion of the bottle chiller 600.

Additionally, the inner member 120, including both the first portion 510 and the second portion 520, may be fixedly secured within the housing 620. However, it is contemplated that the inner member 120, including both the first portion 510 and the second portion 520, may be removably attached within the housing 620. Furthermore, the first portion 510 of the inner member 120 may be removably attached to the second portion 520 of the inner member 120. As illustrated in FIGS. 5 and 6, the second portion 520 slidably engages an inner surface of the housing 620, whereas the first portion 510 refrains from contacting the inner surface of the housing 620, thus creating a vertical gap portion between the housing 620 and the first portion 510 for receiving water and/or ice. The bottle 610 may be a wine bottle or a champagne bottle or a beer bottle or any type of hard liquor bottle or any bottle holding any type of liquid.

At least one advantage of exemplary embodiments of the present disclosure is that a user need not struggle to fit a bottle within an ice bucket filled with ice. In conventional bottle chillers, a user needs to apply a great amount of force to squeeze a bottle through a bucket full of ice. In contrast, according to the exemplary embodiments of the present disclosure, a user may easily fit a bottle into a first portion 510 of an inner member 120 and then pour water via the vertical gap until the second portion 520 is filled with cold water. The user may then pour ice within the vertical gap, such that the ice surrounds or envelops the first portion 510 holding the bottle 610. As such, the water in the second portion 520 and the ice around the first portion 510 of the inner member 120 may conveniently cool the bottle 610. As the ice surrounding the first portion 510 melts, the melted water goes through the plurality of openings 130 of the first portion and the plurality of openings 320 of the second portion 520. Therefore, the water remains within the housing 620 at all times. Obviously, the water may overflow from the second portion 520 and into the first portion 510, as well as into the vertical gap portion.

Alternatively, in another exemplary embodiment, the exterior surface of the housing 620 may include indicators for indicating one or more parameters, at least one parameter being an interior temperature of the bottle chiller 600. The indicators may be visual indicators (e.g., light emitting diodes (LEDs), liquid crystal display (LCD) units, etc.), audible indicators (e.g., sound emitting devices) or a combination thereof.

Alternatively, the dimensions of the first portion 510 may unequally extend within the housing 620 and the dimensions of the second portion 520 may be unequally extend within the housing 620. In other words, the length of the first portion 510 and the length of the second portion 520 may have a varying diameter.

Moreover, while threaded connections may be utilized to connect various components in the described embodiments, many other forms of connections, such as snap together connections, twist-to-lock connections and the like also may be utilized.

Optionally, the body of all bottle chillers of the present disclosure may be constructed of a clear or transparent or translucent material in order to better identify how much water and/or ice is included in the bottle chiller.

Additionally, all the bottle chillers of the present disclosure are not limited to any particular bottle shape or design. Although the bottle chillers are described and depicted herein as being of generally cylindrical upstanding form, the configurations of the containers is a matter of design choice. The use of generally cylindrical containers is described because it gives the bottle chiller a readily acceptable appearance and shape, and because generally cylindrical container shapes tend to work well if one also desires to make use of generally cylindrical, externally threaded container necks. Moreover, generally cylindrical containers tend to efficiently provide good fluid-carrying capacity at relatively low manufacturing cost. While opaque, single-thickness materials may be preferred for use, transparent or plural-layer materials may be used, if desired, to enhance visibility, to provide added insulating capability, or for other purposes.

Moreover, the first chamber and the second chamber of all the bottle chillers of the present disclosure may be designed to contain different ratios of liquids. For example, a 50/50 ratio between the first chamber and the second chamber may be preferred. However, it is envisioned that even a 1/3 to 2/3 ratio may be practical for certain applications.

Furthermore, all the bottle chillers of the present disclosure may include one or more caps or lids, and each of the one or more caps or lids may have a strap connected to the housing of the bottle chiller. All the bottle chillers of the present disclosure may be of different widths and/or heights, and each chamber of all the bottle chillers may be of a different width and/or height. All the bottle chillers of the present disclosure may have different caps of different shapes and/or sizes with a plurality of fastening means. All the bottle chillers of the present disclosure may have interchangeable parts.

Finally, all the bottle chillers of the present disclosure may be constructed by any manufacturing means. For example, blow molding technology may be utilized. A plurality of different types of thermoplastic resins may be utilized in any type of blow molding techniques. Of course, the bottle chiller need not be constructed of plastic materials. The bottle chiller, may, for example, be constructed from metals, such as aluminum or stainless steel, and/or include one or more metallic liners, such as in the inside surface of the housings 110, 620.

It will be understood that there are to be no limitations as to the dimensions and shape of the beverage bottle chiller, including the storage compartment, or the materials from which the beverage bottle chiller is manufactured. The bottle chiller may be constructed to resemble any commercially available bottle chiller for holding a liquid beverage and may be manufactured from any suitable plastic, glass or metal material. Furthermore, it should be understood that the beverage bottle chiller of the present disclosure may be adapted to store any suitable liquid, such as, for example, water, juice, milk, carbonated sodas, protein shakes, energy drinks, beer, wine, and liquor.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

Having described the present disclosure above, various modifications of the techniques, procedures, material and equipment will be apparent to those in the art. It is intended that all such variations within the scope and spirit of the appended claims be embraced thereby.

The foregoing examples illustrate various aspects of the present disclosure and practice of the methods of the present disclosure. The examples are not intended to provide an exhaustive description of the many different embodiments of the present disclosure. Thus, although the foregoing disclosure has been described in some detail by way of illustration and example for purposes of clarity and understanding, those of ordinary skill in the art will realize readily that many changes and modifications may be made thereto without departing form the spirit or scope of the present disclosure.

What is claimed is:

1. A bottle chiller, comprising:
a housing; and
an inner member positioned within the housing, the inner member having a first portion and a second portion such that the first portion rests on the second portion, the inner member including a plurality of spaced apart openings;
wherein the first portion has a first diameter and the second portion has a second diameter, the second diameter being greater than the first diameter.

2. The bottle chiller according to claim 1, wherein the first portion of the inner member is configured to receive a bottle.

3. The bottle chiller according to claim 1, wherein a top circumferential layer of the second portion of the inner member has the plurality of spaced apart openings for receiving water poured into the housing.

4. The bottle chiller according to Claim 1, wherein the second portion of the inner member is configured to receive water and a vertical gap portion extending from an inner surface of the housing to an outer surface of the first portion of the inner member is configured to receive ice.

5. The bottle chiller according to claim 1, wherein the inner member is fixedly secured within the housing.

6. The bottle chiller according to claim 1, wherein the inner member is removably attached within the housing.

7. The bottle chiller according to claim 1, wherein the first portion of the inner member is removably attached to the second portion of the inner member.

8. The bottle chiller according to claim 1, wherein the second portion slidably engages an inner surface of the housing, whereas the first portion refrains from contacting the inner surface of the housing.

9. The bottle chiller according to claim 1, wherein the housing has a variable length diameter extending downward from a top portion to a bottom portion of the bottle chiller.

10. The bottle chiller according to claim 1, wherein an exterior surface of the housing includes indicators for indicating one or more parameters, at least one parameter being an interior temperature of the bottle chiller.

11. The bottle chiller according to claim 10, wherein the indicators are visual indicators, audible indicators or a combination thereof.

12. The bottle chiller according to claim 1, wherein an exterior surface of the housing includes a handle for holding the bottle chiller.

13. The bottle chiller according to claim 1, wherein the bottle chiller is at least one of a wine chiller, a champagne chiller, a beer chiller or a hard liquor chiller.

14. A device for chilling liquids, the device comprising:
an outer chamber having a variable length diameter extending a length of the device; and
an inner chamber having a top portion and a base portion, the base portion having a base diameter greater than a top diameter of the top portion;
wherein the inner chamber is configured to receive a bottle and includes a plurality of spaced apart openings.

15. The device according to claim 14, wherein a top circumferential layer of the base portion of the inner chamber has the plurality of spaced apart openings for receiving water poured into the outer chamber.

16. The device according to claim 14, wherein the base portion of the inner chamber is configured to receive water and a vertical gap portion extending from an inner surface of the outer chamber to an outer surface of the top portion of the inner chamber is configured to receive ice.

17. The device according to claim 14, wherein the base portion slidably engages an inner surface of the outer chamber, whereas the top portion refrains from contacting the inner surface of the outer chamber.

18. The device according to claim 14, wherein an exterior surface of the outer chamber includes indicators for indicating one or more parameters, at least one parameter being an interior temperature of the device, the indicators being visual indicators, audible indicators or a combination thereof.

19. The device according to claim 14, wherein an exterior surface of the outer chamber includes a handle for holding the device.

20. A method of manufacturing a bottle chiller, the method comprising:
forming a housing; and
forming an inner member positioned within the housing, the inner member having a first portion and a second portion such that the first portion rests on the second portion, the inner member including a plurality of spaced apart openings;
wherein the first portion has a first diameter and the second portion has a second diameter, the second diameter being greater than the first diameter;
wherein the second portion slidably engages an inner surface of the housing, whereas the first portion refrains from contacting the inner surface of the housing; and
wherein the housing has a variable length diameter extending downward from a top portion to a bottom portion of the bottle chiller.
